(19) United States
(12) Patent Application Publication
(10) Pub. No.: US 2026/0268599 A1
(43) Pub. Date: Sep. 10, 2026

(54) PARALLEL COMPUTATION OF BOOLEAN LOGIC OPERATIONS FOR MULTI-DIMENSIONAL GEOMETRIES

(71) Applicant: NVIDIA Corporation, Santa Clara, CA (US)

(72) Inventors: Levi BARNES, Lake Oswego, OR (US); Nick LEAF, Seattle, WA (US); Justin LUITJENS, Sandy, UT (US)

(73) Assignee: NVIDIA Corporation, Santa Clara, CA (US)

(21) Appl. No.: 19/073,813

(22) Filed: Mar. 7, 2025

(51) Int. Cl. G06T 17/10; G06F 9/30

(52) U.S. Cl. CPC G06T 17/10; G06F 9/30029

(57) ABSTRACT

In various examples, systems and methods are disclosed relating to implementing parallel computation of Boolean logic operations between 2-D geometric polygon sets. A system can identify a plurality of first edges of a first polygon and a plurality of second edges of a second polygon. The system can generate, based at least on a Boolean operation for the first polygon and the second polygon, a set of intersection points corresponding to intersections between at least one first edge of the plurality of first edges and at least one second edge of the plurality of second edges. The system can generate a directed graph data structure for the Boolean operation using the set of intersection points, and generate an output polygon based at least on the directed graph data structure.

### BACKGROUND

Boolean operations involving sets of two-dimensional (2D) polygons are often performed in various computational fields. For example, computational lithography may involve computing logical AND, OR, or NOT operations over sets of 2D polygons to identify overlap areas. However, it is challenging to efficiently calculate such Boolean operations using parallel processing techniques.

### SUMMARY

Boolean operations for two-dimensional (2D) polygons may be implemented for a variety of use cases, including but not limited to computational lithography or other computer-aided design (CAD) techniques, spatial analysis, image processing (e.g., morphological operations), graphics processing pipelines, or gaming techniques such as collision detection. Traditional approaches for performing Boolean operations implement a “sweep” algorithm that traverses polygon geometry and tracks overlapping/covered regions. However, such approaches rapidly become inefficient for complex geometries due to its inherently serial nature and inability to benefit from parallelization.

To address the limitations of conventional approaches, the systems and methods described herein leverage the representation of 2D polygons as sets of edges. Rather than performing sweep operations, the techniques described herein can detect intersections between edges of 2D polygons to perform Boolean operations. Unlike conventional serial approaches, the techniques described herein can be performed while leveraging parallel processing techniques, significantly improving computational performance. To perform Boolean operations using edges, input layers of 2D polygons can be represented as sets of directed edges, and search operations can be performed to identify intersection points between edges of different polygons. A directed graph can be generated using the resulting intersection points, and the resulting outputs of the Boolean operations can be extracted from cycles/loops detected in the directed graphs.

At least one aspect relates to one or more processors. The one or more processors can include one or more circuits. The one or more circuits can identify a plurality of first edges of a first polygon (e.g., on a first layer) and a plurality of second edges of a second polygon (e.g., on a second layer). The one or more circuits can generate, based at least on a Boolean operation for the first polygon and the second polygon, a set of intersection points (e.g., layer/segment (point) intersections) corresponding to intersections between at least one first edge of the plurality of first edges and at least one second edge of the plurality of second edges. The one or more circuits can generate a directed graph data structure (e.g., including loops/cycles for each output polygon) for the Boolean operation using the set of intersection points. The one or more circuits can generate an output polygon (e.g., result of Boolean operation) based at least on the directed graph data structure.

In some implementations, the Boolean operation comprises an OR operation, an AND operation, an XOR operation, or a NOT operation. In some implementations, the one or more circuits can generate an index value for each of the set of intersection points. The one or more circuits can identify a plurality of index value pairs based at least on the index value of each of the set of intersection points. The one or more circuits can generate the directed graph data structure based at least on the plurality of index value pairs. In some implementations, the one or more circuits can generate the directed graph data structure based at least on a sorting operation for the plurality of index value pairs (e.g., to identify connected index values). In some implementations, the one or more circuits can identify at least one of the plurality of index value pairs based at least on a first coordinate of a first intersection point of the set of intersection points being within a threshold distance of a second intersection point of the set of intersection points.

In some implementations, the one or more circuits can generate a dummy value (e.g., to remove trailing leaf nodes form cycles/loops) for at least one of the sets of intersection points to generate the plurality of index value pairs. In some implementations, the one or more circuits can generate the dummy value for a first intersection point of the set of intersection points that fails to match with a corresponding second intersection point of the set of intersection points. In some implementations, the one or more circuits can generate the output polygon based at least on at least one cycle identified in the directed graph data structure. In some implementations, the one or more circuits can reverse a winding direction for one of the plurality of second edges of the second polygon or the plurality of first edges of the second polygon based at least on the Boolean operation.

At least one other aspect relates to a system. The system can generate a set of links from a plurality of first edges of a first layer of polygons and a plurality of second edges of a second layer of polygons based at least on a Boolean operation. The system can generate a directed graph data structure based at least on a sorting operation for the set of links, each node in the graph corresponding to a respective coordinate. The system can identify at least one cycle within the directed graph. The system can provide an output layer of polygons generated based at least on the respective coordinate of each node in the cycle of the directed graph.

In some implementations, the system can receive the first layer of polygons and the second layer of polygons from a computer-aided design (CAD) application. In some implementations, the system can detect an intersection between a first edge of the plurality of first edges and a second edge of the plurality of second edges. The system can generate a first link of the set of links based at least on a start point of the first edge and an intersection point between the first edge and the second edge.

In some implementations, the Boolean operation comprises an OR operation, and the system can determine, based at least on winding directions of the first edge and the second edge, that the intersection between the first edge and the second edge corresponds to a right turn. In some implementations, responsive to determining that the intersection between the first edge and the second edge corresponds to the right turn, the system can generate a second link of the set of links based at least on (i) the intersection point between the first edge and the second edge, and (ii) one of a second intersection or an end point of the second edge.

In some implementations, the Boolean operation comprises an AND operation, and the system can determine, based on winding directions of the first edge and the second edge, that the intersection between the first edge and the second edge corresponds to a left turn. In some implementations, responsive to determining that the intersection between the first edge and the second edge corresponds to the left turn, the system can generate a second link of the set of links based at least on (i) the intersection point between the first edge and the second edge, and (ii) one of a second intersection or an end point of the second edge.

At least one other aspect relates to a method. The method can include identifying a plurality of first edges of a first polygon and a plurality of second edges of a second polygon. The method can include generating, based at least on a Boolean operation for the first polygon and the second polygon, a set of intersection points corresponding to intersections between at least one first edge of the plurality of first edges and at least one second edge of the plurality of second edges. The method can include generating a directed graph data structure for the Boolean operation using the set of intersection points. The method can include generating an output polygon based at least on the directed graph data structure.

In some implementations, the Boolean operation comprises an OR operation, an AND operation, an XOR operation, or a NOT operation. In some implementations, the method can include generating an index value for each of the set of intersection points. The method can include identifying a plurality of index value pairs based at least on the index value of each of the set of intersection points. The method can include generating the directed graph data structure based at least on the plurality of index value pairs. In some implementations, the method can include generating the directed graph data structure based at least on a sorting operation for the plurality of index value pairs.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a small language model, a system for performing generative AI operations using a large language model, a system for performing generative AI operations using a vision language model, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for implementing parallel computation of Boolean logic operations between 2D geometric polygon sets are described in detail below with reference to the attached drawing figures, wherein:

FIG. 1 is a block diagram of an example system for implementing parallel computation of Boolean logic operations between 2D geometric polygon sets, in accordance with some embodiments of the present disclosure;

FIGS. 2A, 2B, and 2C depict example diagrams showing how search operations can be performed via edges of overlapping polygon layers to perform a Boolean OR operation, in accordance with some embodiments of the present disclosure;

FIGS. 3A, 3B, 3C, 3D, 3E, and 3F depict example diagrams showing the generation of directed graphs for Boolean operations, in accordance with some embodiments of the present disclosure;

FIGS. 4A, 4B, 4C, 4D, 4E, 4F, and 4G depict example diagrams showing a process for detecting cycles/loops in an example directed graph, in accordance with some embodiments of the present disclosure;

FIG. 5 depicts an example diagram showing an example search operation to perform a Boolean AND operation, in accordance with some embodiments of the present disclosure;

FIG. 6 depicts an example diagram showing an example search operation to perform a Boolean NOT operation, in accordance with some embodiments of the present disclosure;

FIG. 7 is a flow diagram of an example of a method for implementing parallel computation of Boolean logic operations between 2D geometric polygon sets, in accordance with some embodiments of the present disclosure;

FIG. 8 is a block diagram of an example computing device suitable for use in implementing at least some embodiments of the present disclosure; and

FIG. 9 is a block diagram of an example data center suitable for use in implementing at least some embodiments of the present disclosure.

### DETAILED DESCRIPTION

In graphics processing, the overlap or relationship between sets of two-dimensional (2D) polygons can be determined through the use of Boolean operations. Boolean operations for 2D polygons may be implemented for a variety of use cases, including but not limited to computational lithography or other computer-aided design (CAD) techniques, spatial analysis, image processing (e.g., morphological operations), graphics processing pipelines, or gaming techniques such as collision detection. Boolean operations such as AND, OR, NOT, and XOR are particularly useful for applications in computational lithography, which may involve processing several layers of 2D polygons.

Traditional approaches to performing Boolean operations for 2D polygons often rely on a “sweep” algorithm that traverses the geometry from one edge to another, keeping track of “covered” regions as it progresses. This method involves iterating through each point along an edge, determining which polygons are intersected, and updating a coverage map accordingly. While effective for smaller geometries, this approach becomes increasingly inefficient as the complexity of each layer increases. This is because approaches for sweeping geometries are inherently serial and cannot be practically parallelized for large numbers of shapes occupying different geometric layers.

To address the limitations of conventional techniques, the systems and methods described herein provide an approach that leverages the representation of 2D polygons as sets of edges. Each polygon is defined by a collection of connected line segments, each having directionality to define exterior and interior boundaries of the polygon. Rather than performing sweep-based coverage detection, the techniques described herein detect intersections between edges of different polygons to perform Boolean operations. Unlike sweep-based approaches, the edge-based Boolean techniques described herein can be calculated in parallel, significantly improving computational performance.

To perform a Boolean operation, input layers of 2D polygons can first be represented as sets of directed edges. Each edge is associated with an index value and can be stored with information about its directionality (e.g., clockwise or counterclockwise). Positive polygons can be wound in a counterclockwise direction, while negative (or hole) polygons can be wound in a clockwise direction. Using directionality permits any type of 2D polygon to be processed using these techniques, including concave polygons or irregular polygons that include holes.

Rather than performing a sweep operation, the intersection points between edges of different polygons can be used to derive the geometry of polygons resulting from different Boolean operations. Intersections between edges of different polygons can be identified by “following” the edges of each polygon to identify intersection points. Different calculations can be performed for different Boolean operations between the layers of 2D polygons. For OR operations, connections/links for output polygons are generated at intersection points of each edge forming the sharpest right turn at the intersection point. For AND operations, connections/links are established with the edge creating the sharpest left turn. NOT operations follow a similar pattern, connecting to edges that form left turns.

Each generated connection/link can be represented by an index pair and coordinate values (“coordinates”), such that one index of the pair points to an “incoming” segment (e.g., the edge making the connection/link) and the second index of the pair points to an “outgoing” segment (e.g., the edge receiving the connection/link). The coordinates can define the point in space at which the intersection is detected. A directed graph can then be generated from these connections/links. Each outgoing segment of one connection/link can be matched to another incoming segment and starting point from another connection/link. Unmatched outgoing segments can be stored as leaf nodes in the directed graph.

Cycles/loops identified within the directed graph can be performed to identify the resulting polygons to be defined in an output layer. Parallel graph processing techniques can be implemented to detect cycles/loops in the graph to improve computational efficiency. Each cycle/loop identified in the graph can represent a polygon in the output layer. Validation can be performed to validate the output polygons to ensure they do not include self-intersections or degenerate shapes. The resulting output shapes can be defined on one or more output layers of 2D polygons, which can be provided for display or processed in further downstream tasks.

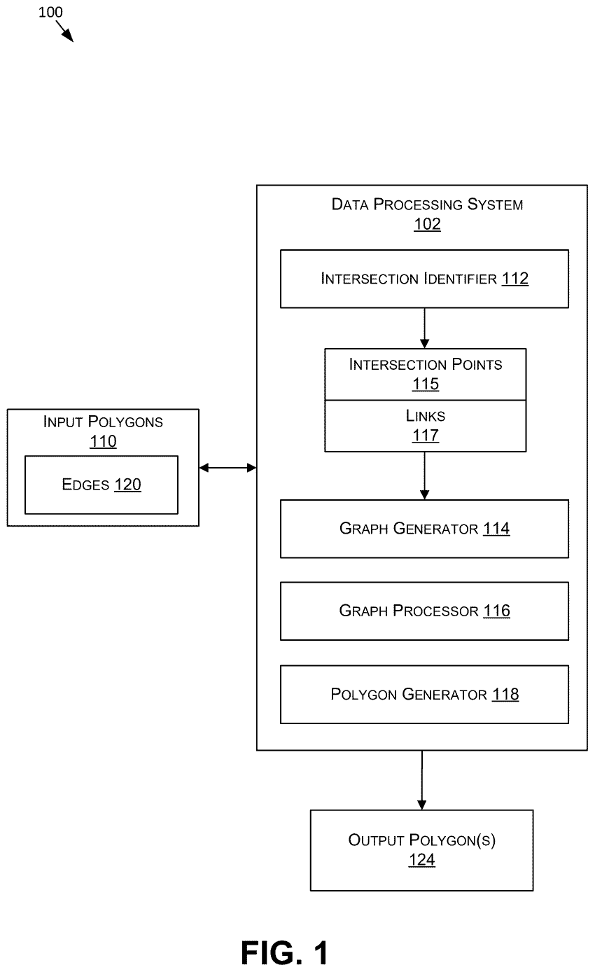

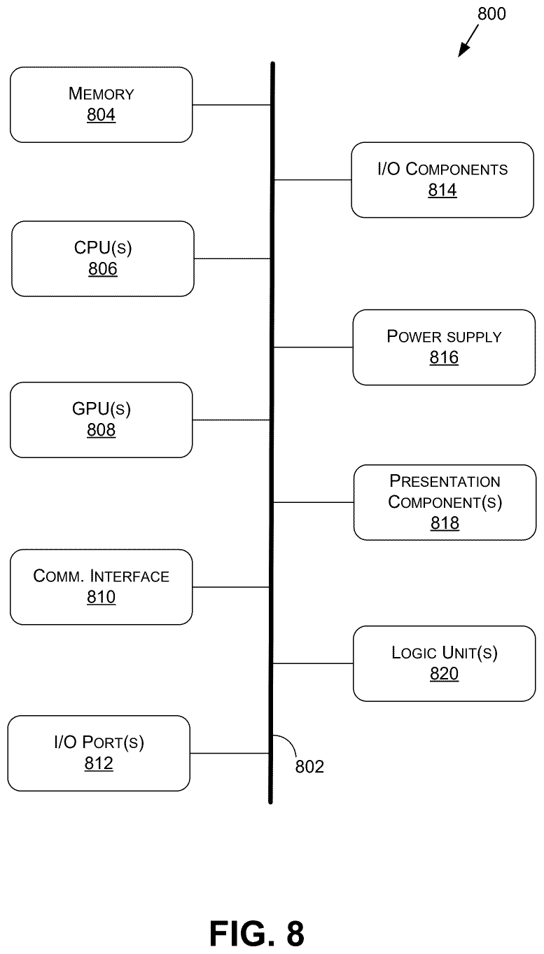

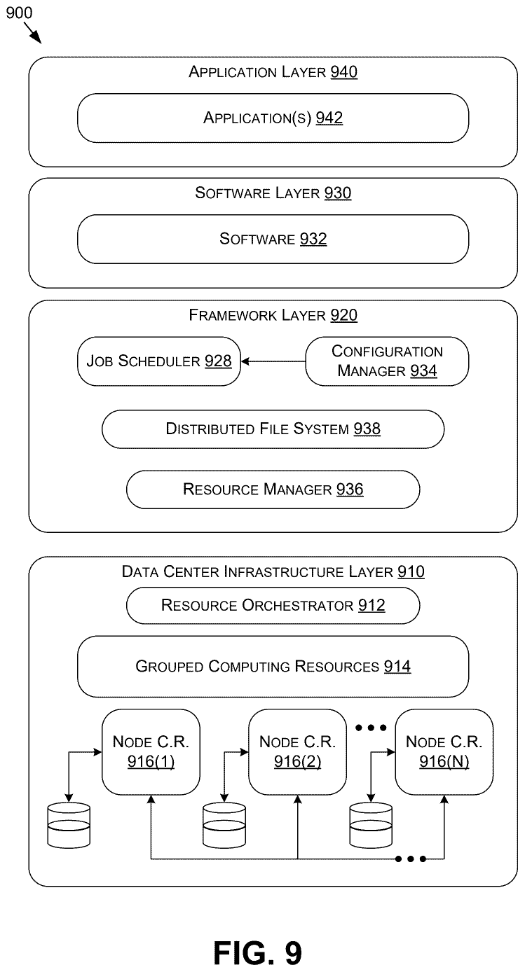

With reference to FIG. 1, FIG. 1 is an example computing environment including a system 100 for implementing parallel computation of Boolean logic operations between 2D geometric polygon sets, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. For example, in some embodiments, the system and methods described herein may be implemented using one or more computing devices or components thereof (e.g., as described in FIG. 8), and/or one or more data centers or components thereof (e.g., as described in FIG. 9).

The system 100 can be used to implement parallel computation of Boolean logic operations between sets of 2D polygons. The system is shown as including a data processing system 102, input polygons 110 (e.g., input layers of polygons 110) and output polygon(s) 124 (e.g., an output layer of output polygon(s) 124). The data processing system 102 is shown as including an intersection identifier 112 that can identify/extract intersection points 115 and/or links 117, a graph generator 114, a graph processor 116, and a polygon generator 118. Each of the intersection identifier 112, the graph generator 114, the graph processor 116, and the polygon generator 118 can include or be implemented in hardware, software, or any combination of hardware and software.

As described in further detail herein, the data processing system 102 can implement parallel computation of Boolean logic operations between sets of input polygons 110 using the edges 120 defined in one or more polygon layers. To do so, the intersection identifier 112 can detect intersections between edges 120 of different polygons 110, generating intersection points 115 and corresponding links 117 associated therewith based at least on the Boolean operation to be performed. The graph generator 114 can generate a directed graph data structure using the intersection points 115 and corresponding links 117. Nodes in the graph can represent candidates coordinates of points for output polygons 124. The graph processor 116 can identify cycles/loops within the directed graph to identify the output polygons 124 following Boolean operations. The polygon generator 118 can extract the output polygons 124 using the coordinates and edges of the cycles in the directed graph to generate the output polygon(s) 124 for the Boolean operation.

The data processing system 102 can include one or more processors, circuits, memory, and/or computing devices/systems that can perform the various techniques described herein. The data processing system 102 can be implemented, for example, in a cloud computing environment, in a computing server, or in a personal computing device, among other types of computing devices. In some implementations, the data processing system 102 can execute and/or receive requests from other computing systems and/or processes. For example, the data processing system 102 may initiate a Boolean operation for one or more sets of input polygons 110 in response to a request from an external computing system, in response to a signal from another process executing on the data processing system 102, or in response to operator input (e.g., an interaction) at the data processing system 102, among others.

The data processing system 102 can identify a set of input polygons 110 for one or more Boolean operations. The input polygons 110 can be or include any 2D geometric shape defined by a set of vertices and edges 120. The input polygons 110 may correspond to different forms of data, such as shapes in computer-aided design (CAD) applications, regions in geographic information systems (GIS), or objects in image processing tasks, among others. The input polygons 110 may be included in one or more 2D layers of polygons. In such implementations, each layer can include multiple polygons that are each associated with a common layer identifier. The input polygons 110 can include a set of edges 120. The edges 120 can be directional edges that can connect the vertices of the input polygons 110 to define the boundaries thereof.

The data processing system 102 can access the input polygons 110 to perform a corresponding Boolean operation. The input polygons 110 can be stored in memory of the data processing system 102, received from an external computing system, received, retrieved, or otherwise accessed from a process executing on the data processing system 102, or retrieved from external storage repositories or databases, among other data sources. The input polygons 110 can be represented in various formats, including but not limited to a list of vertices in an adjacency list or matrix/data structure, a set of edges with corresponding start and edge coordinates, or combinations thereof, among others.

The input polygons 110 may have any shape and size, including convex, concave, or irregular polygons. The polygons can also include holes, which are defined by inner boundaries that are separate from the outer boundaries. The edges 120 of the input polygons 110 can be directed edges. For example, each edge 120 can have a directionality that defines the interior and exterior of the polygon. This direction can be referred to as the “winding rules” or “winding directions” of the input polygons 110. In one example, positive polygons can be assumed to be counterclockwise wound, while negative polygons (e.g., holes) can be wound clockwise. The direction of each edge 120 can be specified using a corresponding identifier or flag stored in association with an identifier of the corresponding edge 120.

The data processing system 102 can access the input polygons 110 to perform a corresponding Boolean operation by first identifying intersection points between the edges 120 of different polygons. The data processing system 102 can access the input polygons 110 to perform a requested and/or specified Boolean operation, such as an OR, AND, XOR, or NOT operation, among others. The Boolean operation may be specified in a request that indicates or provides the input polygons 110 to be processed using the Boolean operation. The request may be received from an external computing system (e.g., via an application programming interface (API), etc.), from operator input at the data processing system 102, or from a process executing on the data processing system 102, among others.

The data processing system 102 can execute the intersection identifier 112 to generate a set of intersection points 115 and corresponding links 117 based at least on the Boolean operation. To do so, the intersection identifier 112 can iterate through each edge 120 for each polygon 110, starting at a starting point of an edge 120 of an input polygon 110 that has not been traversed. The intersection identifier 112 can search along that edge 120 in its winding direction for an intersecting edge 120 (e.g., in another polygon layer, corresponding to a different polygon/layer identifier, etc.). If the intersection identifier 112 identifies an intersecting edge 120, the intersection identifier 112 can determine whether the intersection edge 120 forms a turn having a direction associated with the Boolean operation being performed. For example, the intersection identifier 112 can identify (e.g., following the winding direction of the intersecting edge 120) right turns for OR operations and left turns for AND operations. Other operations, such as NOT and XOR operations, may involve combinations of other Boolean operations, as described in further detail herein.

If the intersecting edge 120 forms a turn corresponding to the Boolean operation being performed, the intersection identifier 112 can generate an intersection point 115 that includes the coordinate of the intersection. The intersection identifier 112 can associate the generated intersection point 115 with the starting point of the search (e.g., the starting point along the edge 120 being searched) to generate a link 117 that starts at the coordinate of the starting point of the search and ends at the intersection point 115. The intersection identifier 112 can switch to traversing the intersecting edge 120 in the winding direction, starting at the coordinate of the intersection point 115. In some implementations, the intersection point 115 can be stored in association with characteristics of the intersection/turn, such as the angle between the searched edge 120 and the intersecting edge 120. The angle of the intersection can be used to generate or to resolve instances where multiple edges intersect at a common coordinate (e.g., within a predetermined threshold region of the coordinate), as described in further detail herein.

The intersection identifier 112 can search for intersecting edges along the intersecting edge 120, starting at the generated intersection point 115 and following the winding direction of the intersecting edge 120. If no turn corresponding to the Boolean operation is found during the search, the intersection identifier 112 can move to the next edge of the current polygon and repeat the search process. The intersection identifier 112 can continue this iterative process until all edges 120 of the input polygons 110 have been traversed and all relevant intersection points 115 and corresponding links 117 have been identified. This can include continuing to search the initial edge starting at any generated intersection points 115 until the entirety of all edges have been searched for potential links 117.

The intersection identifier 112 can store each of the intersection points 115 and the links 117 in one or more data structures in memory of the data processing system 102. The intersection points 115 can be stored in any suitable format. In some implementations, the intersection points 115 can be stored as part of the links 117. The links 117 can be stored in any suitable format. For example, the links 117 may be stored in a format that includes a start coordinate and an end coordinate. The start coordinate can be associated with an “incoming” segment (e.g., the edge 120 being searched) and the end coordinate can be associated with an “outgoing” segment (e.g., the intersecting edge 120 of a second polygon). In one example, link 117 can include a starting coordinate/point that is stored in association with an identifier of the polygon layer of the corresponding incoming edge 120, an edge identifier of the incoming edge 120, and a set of coordinates (e.g., cartesian coordinate) of the starting coordinate/point. Furthering this example, an end point of the link 117 can include an identifier of the polygon layer of the corresponding outgoing edge 120, an edge identifier of the outgoing edge 120, and a set of coordinates (e.g., cartesian coordinate) of the end coordinate/point. If the end point is an intersection point 115, the edge identifier can be the identifier of the intersecting edge 120 detected during the search. If the end point is the end of the edge 120 being searched, the edge identifier of the outgoing edge 120 can be the identifier of the incoming edge 120 (e.g., the same edge identifier).

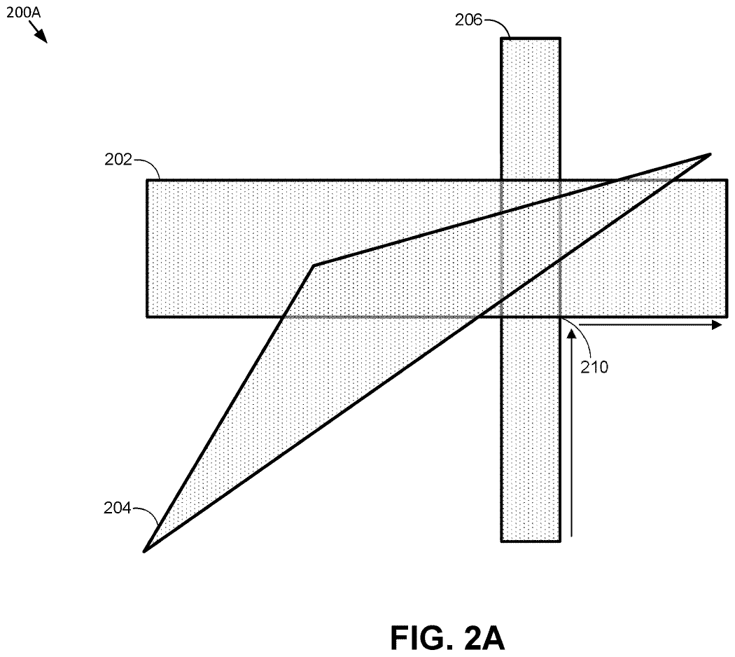

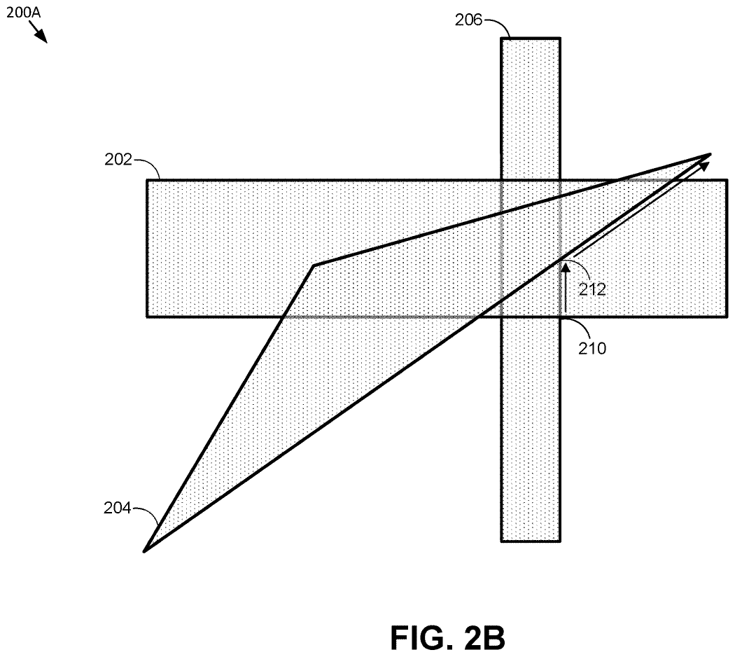

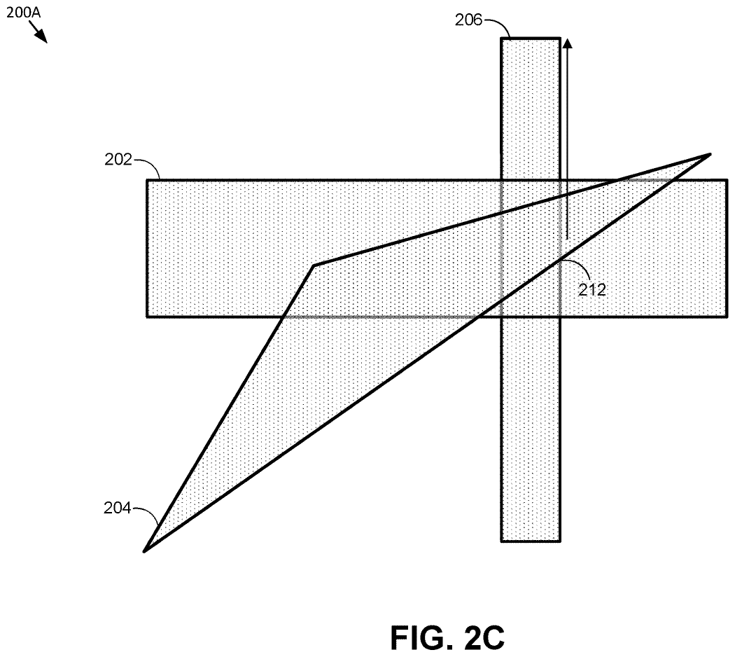

In some implementations, the intersection identifier 112 can execute multiple edge searches in parallel to generate the intersection points 115 and corresponding links 117. In one example, the intersection identifier 112 can initiate multiple threads or processes to concurrently search for intersecting edges 120 across different polygons. Performing the searches may include initializing one or more processing kernels and/or storing information relating to the edges 120, input polygons 110, and the Boolean operation in corresponding regions of memory of one or more parallel processing devices, such as graphics processing units (GPUs). Each thread, process, or kernel can execute to independently perform the search for intersection points 115 and corresponding links 117 for different edges 120 in the input polygons 110 according to the Boolean operation. The threads, processes, and/or kernels initiated to perform the search may coordinate using suitable communication techniques to prevent duplicate searches of the same of edges 120 or portions (e.g., segments) thereof. The intersection identifier 112 can store the resulting intersection points 115 and links 117 (and any additional data, such as turn angle information, etc.) in memory accessible by other components of the data processing system 102. An example representation of searches performed according to the functionality of the intersection identifier are described in connection with FIGS. 2A, 2B, and 2C.

Referring to FIGS. 2A, 2B, and 2C in the context of the components described in connection with FIG. 1, depict example diagrams 200A, 200B, and 200C showing how search operations can be performed via edges of overlapping polygon layers to perform a Boolean OR operation, in accordance with some embodiments of the present disclosure. FIG. 2 shows an example diagram 200A showing first polygon 202, a second polygon 204, and a third polygon 206, which are overlapping. In this example, a search is performed along a right edge of the third polygon 206 starting at the bottom-right vertex of the third polygon 206. The intersection identifier 112 can perform the search in the winding direction (counterclockwise, in this example).

As shown, the search is performed until an intersection point 210 is detected, which in this example is between the edge being searched and the bottom edge of the first polygon 202. When an intersection point 210 is detected, the intersection identifier 112 can generate a link 117 corresponding to the intersection. The link 117 can be generated according to the direction of the intersecting edge relative to the direction of the search and the Boolean operation being performed. In this example, the Boolean operation is an OR operation. Since the intersecting edge in this example is a right hand turn and the Boolean operation is an OR operation, the intersection identifier 112 can generate a link 117 including the intersection point 210 (e.g., as an intersection point 115) according to the techniques described herein. If the Boolean operation were an AND operation or a NOT operation, the intersection identifier 112 would instead generate links 117 for left-hand turns, which does not occur in this instance.

As described herein, once the intersection identifier 112 generates the link 117, the search can continue starting at the intersection point 210 and following the winding direction of the intersecting edge. In this example, this edge does not intersect with any other edges in the direction of the search. When the search reaches the end of the edge, the intersection identifier 112 can generate a link 117 specifying the beginning and end coordinates of the portion of the edge being searched, which can share a common edge and layer identifier. The intersection identifier 112 can proceed to search a next unsearched edge (or portion thereof) in the polygons 202, 204, and 206 according to the techniques described herein.

FIG. 2B shows a diagram 200B depicting a further iteration of the searching process, which involves searching the same edge traversed in diagram 200A starting at the detected intersection point 210. As shown, the search is performed until an intersection point 212 is detected, which in this example is between the edge being searched and the bottom edge of the second polygon 204. When an intersection point 212 is detected, the intersection identifier 112 can generate a link 117 corresponding to the intersection. The link 117 can be generated according to the direction of the intersecting edge relative to the direction of the search and the Boolean operation being performed. As described above, in this example the Boolean operation is an OR operation, the intersection identifier 112 can generate a link 117 including the intersection point 212 (e.g., as an intersection point 115) according to the techniques described herein, as the intersection corresponds to a right-hand turn.

The search can continue along the intersecting edge in the winding direction of the second polygon 204, which in this example is counterclockwise, as the second polygon 204 is a positive polygon. Although the intersecting edge appears to intersect with the top-most edge of the first polygon, this intersection is ignored because it corresponds to a left-hand turn. As described herein, intersections having left-hand turns can be ignored for OR operations. When performing Boolean OR operations, searches can continue past any ignored intersections until the end of the edge is reached or another right-hand intersection is reached. In this example, the search continues until the end of the edge.

FIG. 2C shows a diagram 200C depicting another iteration of the searching process, in which the same edge as that searched in the diagram 200A FIG. 2A and the diagram 200B of FIG. 2B is searched along its winding direction starting at the detected intersection point 212. In this example, no right-hand turns are detected following the winding direction of the searched portion of the edge, with the left-hand intersections with the top-most edges of the second polygon 204 and the first polygon 202 being ignored because they correspond to left-hand turns. The search continues until the end of the edge, and the intersection identifier 112 can generate a link corresponding to the search ending at the link. The intersection identifier 112 can perform the described search operations for each edge of each layer of polygons, to generate a set of links 117 including corresponding intersection points 115, as described herein.

Referring back to FIG. 1, the data processing system 102 can execute the graph generator 114 to generate a directed graph data structure. The graph data structure can be a data structure that specifies a directed graph connecting the set of links 117 generated by the intersection identifier 112 using the coordinates of the intersection points 115. As described herein, a link 117 can include an incoming edge with a corresponding start coordinate and an outgoing edge with a corresponding end coordinate. Each link 117 of the set of links 117 can be represented as a node in the directed graph data structure. To make connections for the graph data structure, the data processing system 102 can match each end coordinate of each link 117 to a corresponding start coordinate of another link 117 in the set of links 117 and generate a directed edge between the corresponding nodes in the directed graph data structure.

To identify the correspondences, the graph generator 114 can iterate through each of the links 117 and compare the outgoing segment information (e.g., layer identifier, edge identifier, coordinate information) to the incoming segment information of each other link 117 in the set of links 117. In some implementations, rounding or similar techniques may be performed to account for situations where the coordinates are proximate but not exactly equal. For example, in some implementations, when identifying a match for an outgoing segment, if the incoming layer and edge identifiers for an incoming segment match but the coordinates do not match, the graph generator 114 can determine whether the coordinates of the incoming segment are within a threshold distance (e.g., a Euclidean distance, etc.) of the coordinates of the outgoing segment. The threshold may be specified via a configuration setting stored in memory of the data processing system 102, provided via operator input to the data processing system 102, or provided in the request to perform the Boolean operation, among other data sources.

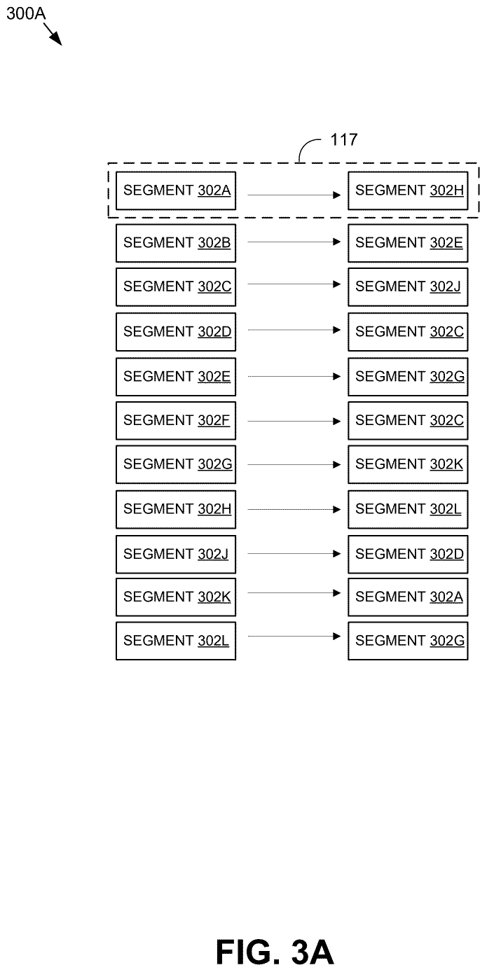

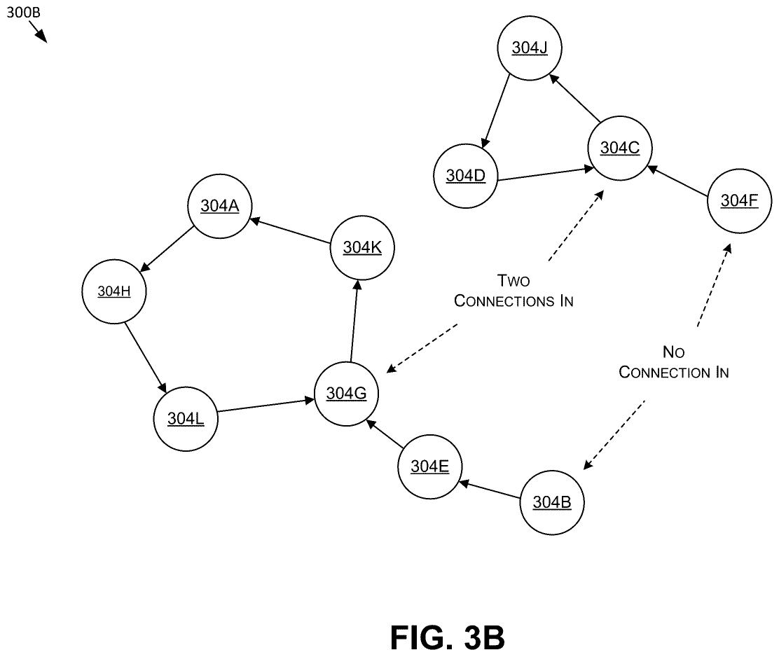

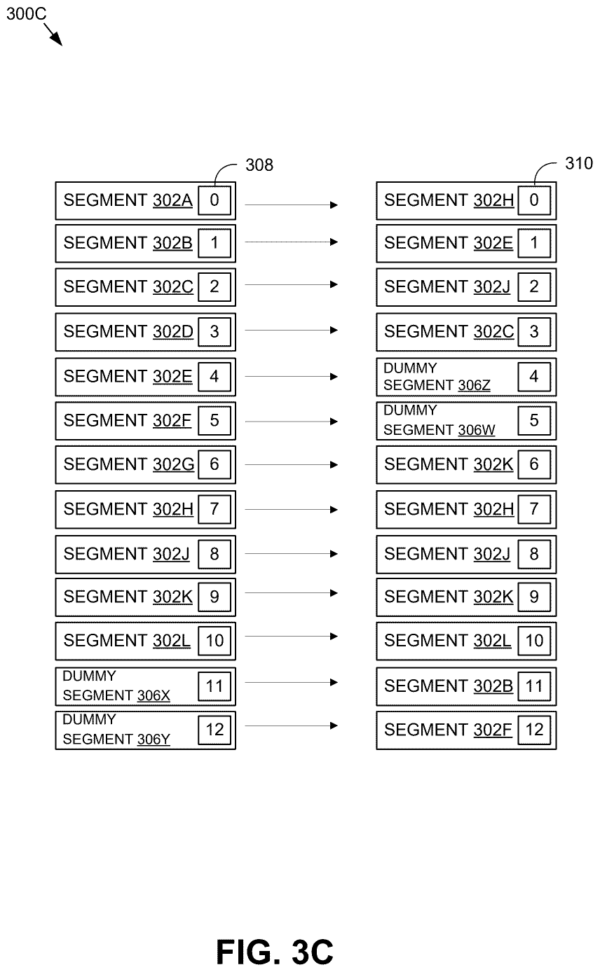

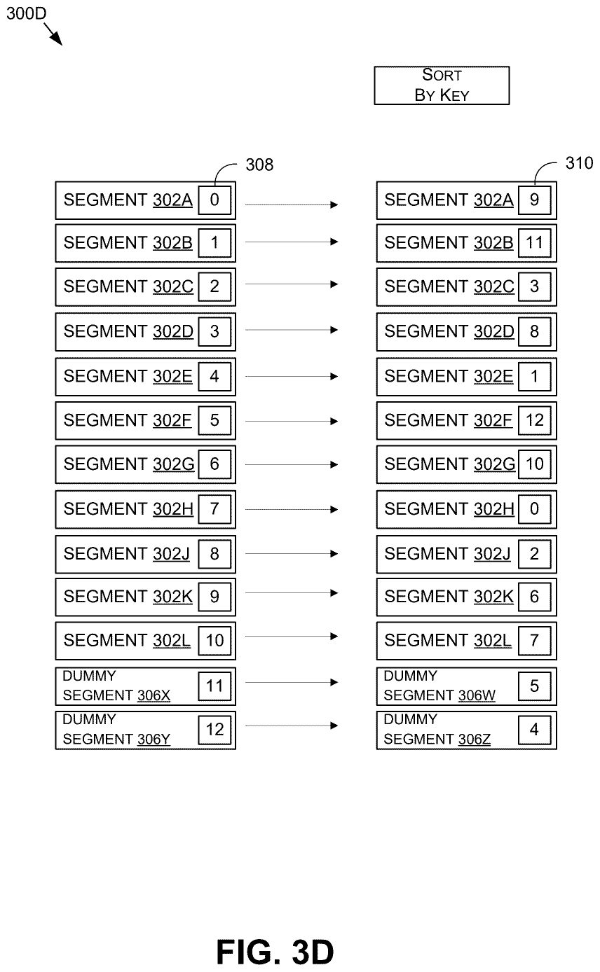

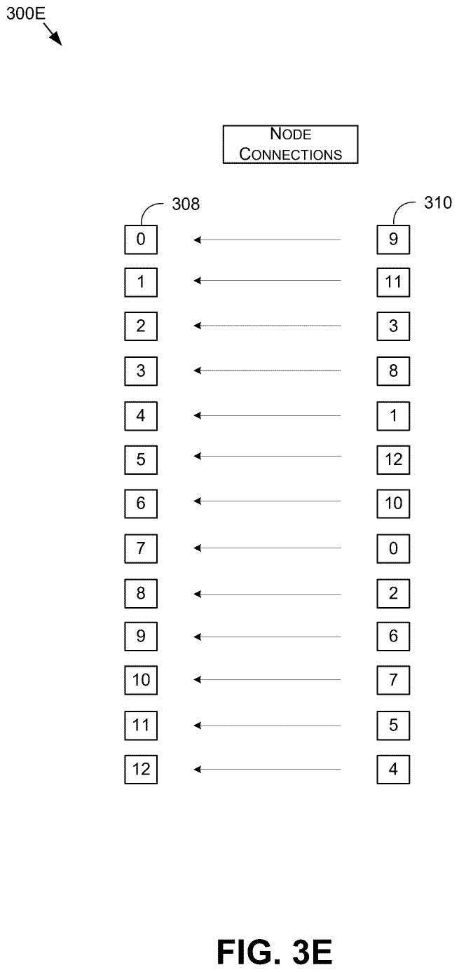

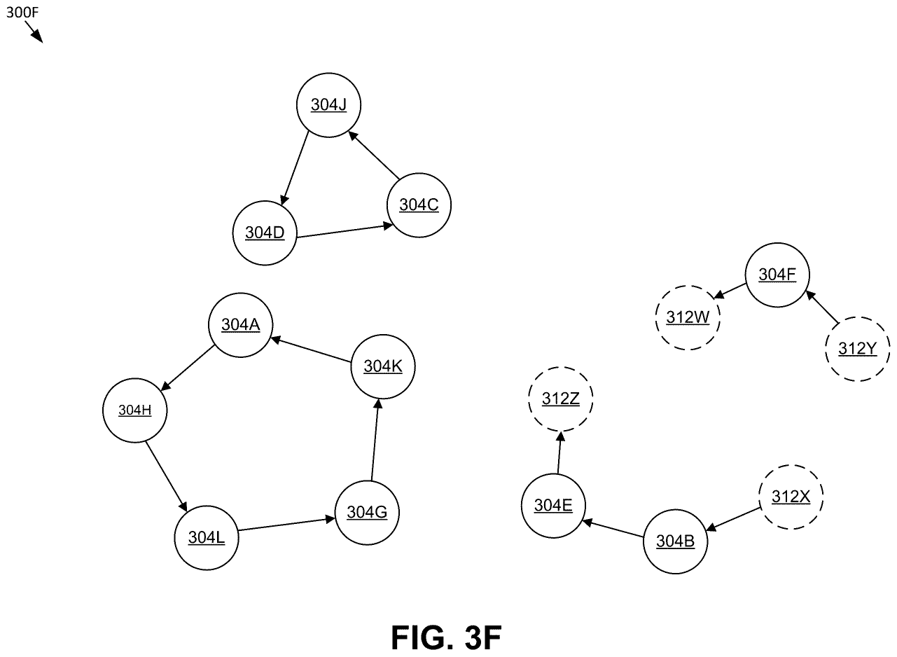

As each of the polygons searched by the intersection identifier 112 are closed, each outgoing segment of the links 117 can match to a corresponding incoming segment of the set of links 117. Upon identifying a match for a link 117, the graph generator 114 can generate a directed edge starting at the node representing the link 117 and pointing to the link 117 having the matching incoming segment. The graph generator 114 can repeat this process until all outgoing segments have been matched to a corresponding incoming segment in the graph. An example representation of the matching and the directed graph corresponding thereto is shown in FIGS. 3A and 3B.

Referring to FIGS. 3A and 3B in the context of the components described in connection with FIG. 1, depicted are diagrams 300A and 300B of an example set of links 117 and a graph. FIG. 3A illustrates a diagram 300A showing an example format of a set of links 117 and the segment information stored therein. In this example, the searching process for a Boolean operation has detected/generated segments 302A-302L (sometimes generally referred to as “segment(s) 302”, note that segment “302I” is omitted for ease of visualization). Each link 117 is shown as having an incoming segment 302 (e.g., the first incoming segment in the first link 117 being the segment 302A) and an outgoing segment 302 (e.g., the first outgoing segment in the first link 117 being the segment 302H). To generate a directed graph, the graph generator 114 can match each of the outgoing segments 302 to a corresponding incoming segment 302 according to the techniques described herein, generating an edge in the graph connecting the nodes representing the matched links 117. An example directed graph corresponding to the links shown in FIG. 3A is illustrated in FIG. 3B.

FIG. 3B depicts a diagram 300B of an example directed graph including nodes 304A-304L (sometimes generally referred to as “node(s) 304”, note that node “304I” is omitted for ease of visualization). In this example, each of the nodes 304A-304K respectively correspond to the links 117 having the incoming segments 302A-302K shown in FIG. 3A. As shown, each of the nodes 304 are connected using directed edges. The graph generator 114 can create the directed edges to connect the nodes 304 by matching corresponding outgoing segments 302 to corresponding incoming segments. For example, the node 304A can represent the link 117 having the incoming segment 302A, and the node 304H can represent the link 117 having the incoming segment 302H. As the link 117 shown in FIG. 3A indicates that first link 117 includes the incoming segment 302A and an outgoing segment 302H. To create the directed edge between the nodes 402A and 402H, the graph generator 114 can search through the set of incoming segments of the links 117 to determine if any link 117 has an incoming segment that matches the outgoing segment 302H. In this example, the link 117 having the incoming segment 302H and the outgoing segment 302L satisfies this matching criterion. The graph generator 114 can generate the directed edge between the corresponding nodes 304A and 304H to represent this match.

The graph generator 114 can repeat this process until all nodes 304 (e.g., links) have been connected to at least one other node 304 in the graph. As shown, depending on the links 117 generated during the searching process, certain nodes 304 have more than one incoming connection. As shown, the node 304G has incoming connections from both the nodes 304L and 304E, and the node 304C has incoming connections from the nodes 304D and 304F. Additionally, as shown in this example, the nodes 304B and 304F are leaf nodes with no incoming connections. For the directed graph to be generated such that it may be used in connection with the Boolean operations described herein, the graph generator 114 can generate the directed graph to be a one-to-one permutation. In other words, the graph generator 114 can generate the directed graph such that each node 304 that represents a link 117 can have both a single incoming connection and a single outgoing connection. To address situations where nodes 304 have multiple incoming connections or no incoming connections, the graph generator 114 can generate one or more dummy nodes for inclusion in the directed graph.

Referring to FIGS. 3C, 3D, 3E, and 3F in the context of the components described in connection with FIG. 1, illustrated are diagrams 300C, 300D, 300E, and 300F that show how dummy segments can be introduced into the set of links 117 to generate a directed graph as a one-to-one permutation. FIG. 3C shows an example diagram 300C shows the set of links 117 shown in the diagram 300A of FIG. 3A with additional dummy segments 306W, 306X, 306Y, and 306Z. Each of the dummy segments 306W, 306X, 306Y, and 306Z can include dummy/placeholder values that do not actually correspond to intersection or vertex points on any polygon. In some implementations, the dummy segments 306W, 306X, 306Y, and 306Z can include large values for edge identifier, layer identifier, and/or coordinate values (e.g., dummy values) selected within a predetermined range (e.g., a range near a predetermined maximum value that exceeds any layer identifier, edge identifier, or coordinate value of an actual segment 302, etc.). The dummy segments 306W, 306X, 306Y, and 306Z may sometimes be referred to generally as the “dummy segment(s) 306).

The graph generator 114 can generate dummy segments 306 that are paired with segments 302 having no incoming connections. As shown in FIG. 3B, the nodes 304B and 304F, which correspond to links 117 having incoming segments 302B and 302F, do not have any incoming connections. As shown, the graph generator 114 can generate the dummy segments 306X and 306Y as part of a dummy link that includes the segments 302B and 302F, respectively, as outgoing segments, as shown. The dummy segments are shown at the bottom of the set of segments in the diagram 300C and can be used to generate dummy nodes in the directed graph, as described in further detail herein.

The graph generator 114 can generate dummy segments 306 to address situations where multiple incoming segments 302 are paired with the same outgoing segment 302. As shown in FIG. 3A, the segments 302G and 302C are each listed as outgoing segments in multiple links 117, and therefore are represented as nodes 304G and 304C having multiple incoming connections in the directed graph shown in FIG. 3B. To do so, the graph generator 114 can iterate through the outgoing segments 302 of each link 117 to identify repeated outgoing segments 302 (such as the segments 302C and 302G, as shown in FIG. 3A). Repeated outgoing segments 302 in the links 117 represent multiple connections to the same segment. To identify which of those links 117 should be associated with a dummy segment 306, rather than the repeated segment, the graph generator 114 can access the segment information stored in the link 117 to identify the turn angle associated with the connection between segments.

The graph generator 114 can select the link 117 having the sharpest turn (e.g., the lowest angle) as having a real connection/link to the outgoing segment. Any other links 117 having the same outgoing segment 302 can be replaced with a dummy segment 306. In this example, the links 117 having incoming segments 302E and 302F, which were previously indicated as connecting to outgoing segments 302G and 302C, respectively. As shown, these connections have been replaced with corresponding connections to dummy segments 306Z and 306W, respectively. Once the dummy segments have been generated, the graph generator 114 can generate a directed graph including dummy nodes representing the dummy connections/links using a sorting operation.

As shown in the diagrams 300A and 300C of FIGS. 3A and 3C, prior to generating dummy segments the graph generator 114 can sort the list of links 117 by incoming segment 302. The dummy segments 306 added as incoming segments for dummy links (e.g., the incoming segments 306X and 306Y) can be generated to include identifier values and/or coordinates that are relatively large values, such that they appear at the end of the list, as shown. The sorting operation performed by the graph generator 114 can sort by any of the values of the incoming segments 302 in a priority order. In one example, the sorting operation can first sort the links according to the layer identifier of the incoming segment, then by the edge identifier, and then by the coordinate values of the incoming segment 302.

To generate the directed graph, an incoming index value 308 can be generated for each of the incoming segments 302 of each link 117. In this example, the index values range, in order, from zero to twelve. However, any suitable index value may be used. The graph generator 114 can generate matching outgoing index values 310 to each of the outgoing segments 302, as shown. The index values can be used as node identifiers and can be used to derive the edges between nodes in a directed graph as described in further detail herein.

Once the incoming index values 308 and the outgoing index values 310 have been assigned to the segments 302 of each link, the graph generator 114 can execute a sort operation to sort the outgoing segments by their segment information (e.g., a sort by key operation, where the segment information operates as the key for the segment). The sorting operation performed by the graph generator 114 can sort by any of the values of the incoming segments 302 in a priority order. In one example, the sorting operation can first sort the links according to the layer identifier of the outgoing segment, then by the edge identifier, and then by the coordinate values of the outgoing segment 302 of each link 117.

FIG. 3D shows an example diagram 300D representing an output of the sorting operation. As shown, each of the incoming segments in the list of links, and their corresponding incoming index values 308, are unchanged. Each of the outgoing segments 302, and their corresponding outgoing index values 310, have been sorted according to the segment information. As a result, the outgoing segments 302 appear in the same order as, and are associated with, the incoming segments with matching segment information, as shown. The dummy segments 306W and 306Z appear at the bottom of the list, as the segment values for those dummy nodes were selected to exceed the values of any actual link 117 generated by the intersection identifier 112. The association between the incoming index values 308 and the outgoing index values 310 can be used to derive connections between nodes in the directed graph.

In some implementations, rather than performing a sorting operation, a search operation (e.g., a binary search operation) can be performed to match the outgoing segments to corresponding incoming segments. In such implementations, the search operation can identify each of the outgoing segments that connect to at least one corresponding incoming segment without necessarily using dummy segments 306. For example, the search operation, once completed, may result in a list of outgoing segments 302 that match to corresponding incoming segments 302, with a remainder set of incoming segments 302 that are not matched to at least one outgoing segment, as well as a remainder set of outgoing segments 302 that do not match to at least one incoming segment. Unmatched segments can be removed from the set, resulting in nodes of a directed graph that have one incoming connection and one outgoing connection, as described herein.

FIG. 3E shows an example diagram 300E that shows how the incoming index values 308 and the outgoing index values 310 can represent connections between nodes. The index values shown can represent identifiers of nodes and the associations between the incoming index values 308 and the outgoing index values 310 can be used to define edges between the nodes. The outgoing index values 310 derived from sorting the outgoing segments can represent the identifier of a starting node for an edge, and the associated incoming index values 308 can represent the identifier of an ending node for the edge.

As described herein, each node in the directed graph can correspond to a respective link 117 generated by the intersection identifier 112. The graph generator 114 can use the incoming index value 308 or outgoing index value 310 as a lookup in the set of links 117 to identify the corresponding link 117. For example, the outgoing index value “9” can correspond to the link having the incoming segment 302K, and the incoming index value “0” can correspond to the link having the incoming segment 302A as shown in FIGS. 3C and 3D. Furthering this example, the association between the outgoing index value “9” and the incoming index value “0” indicates an edge between the nodes representing these two links. An example directed graph generated based on the incoming index values 308 or outgoing index values 310 is shown in FIG. 3F.

FIG. 3F depicts a diagram 300F of an example directed graph similar to the directed graph shown in the diagram 300B of FIG. 3B. As in the directed graph 300B, in this example, each of the nodes 304A-304K respectively correspond to the links 117 having the incoming segments 302A-302K shown in FIG. 3C. Additionally, the directed graph includes the dummy nodes 312W, 312X, 312Y, and 312Z (sometimes generally referred to as the “dummy node(s) 312”), which respectively correspond to the dummy links/dummy segments 306W, 306X, 306Y, and 306Z. The graph generator 114 can create the directed edges to connect the nodes 304 by matching outgoing index values 310 to corresponding incoming index values 308 and connecting the nodes in the graph that correspond to those index values. By connecting the nodes 304 in this manner, each node 304 that represents an actual link in a polygon has at least one incoming connection and at least one outgoing connection.

Referring back to FIG. 1, once the directed graph (including any dummy nodes) has been generated, the data processing system 102 can execute the graph processor 116 to identify loops/cycles within the directed graph. In one example, the graph processor 116 can traverse the directed graph to detect closed paths where the starting and ending nodes are the same, indicating the presence of a cycle/loop. Cycles/loops within the directed graph can represent closed polygons, as each cycle in the directed graph can correspond to a set of connected links that form a closed boundary. The polygons represented by the cycles/loops within the directed graph can represent the polygons generated as an output of the Boolean operation. Any suitable technique can be used to identify closed loops/cycles within the directed graph. For example, the graph processor 116 can employ various graph traversal algorithms, such as depth-first search (DFS) or breadth-first search (BFS), among others, to automatically identify any cycles/loops within the directed graph.

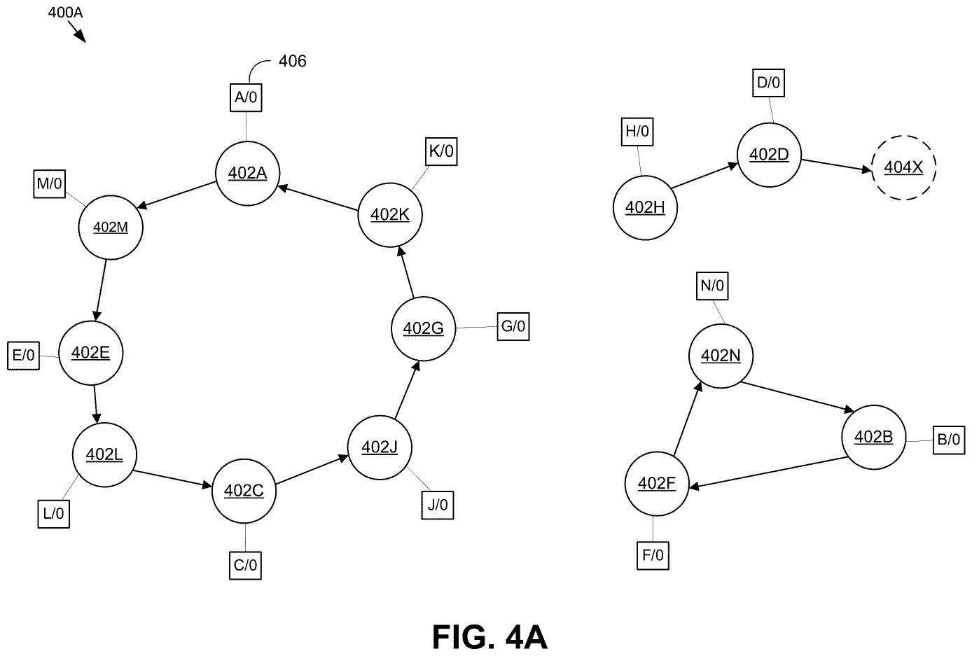

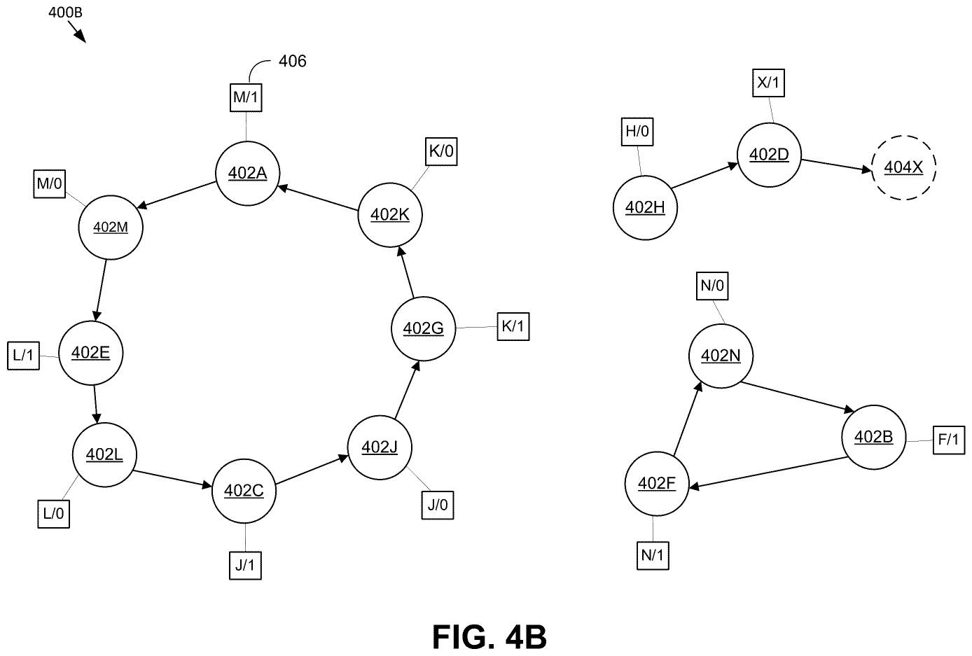

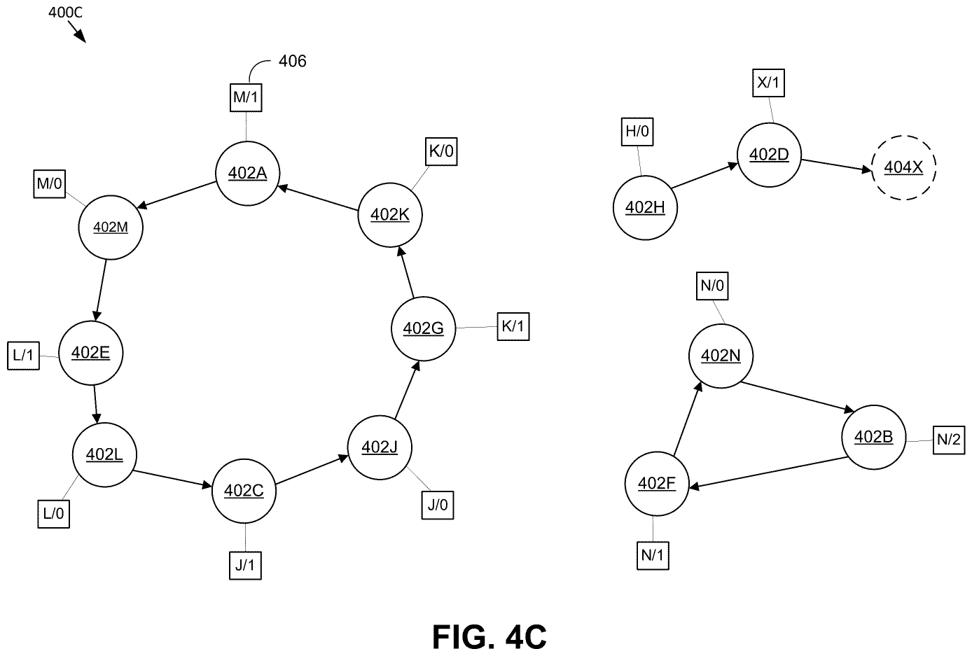

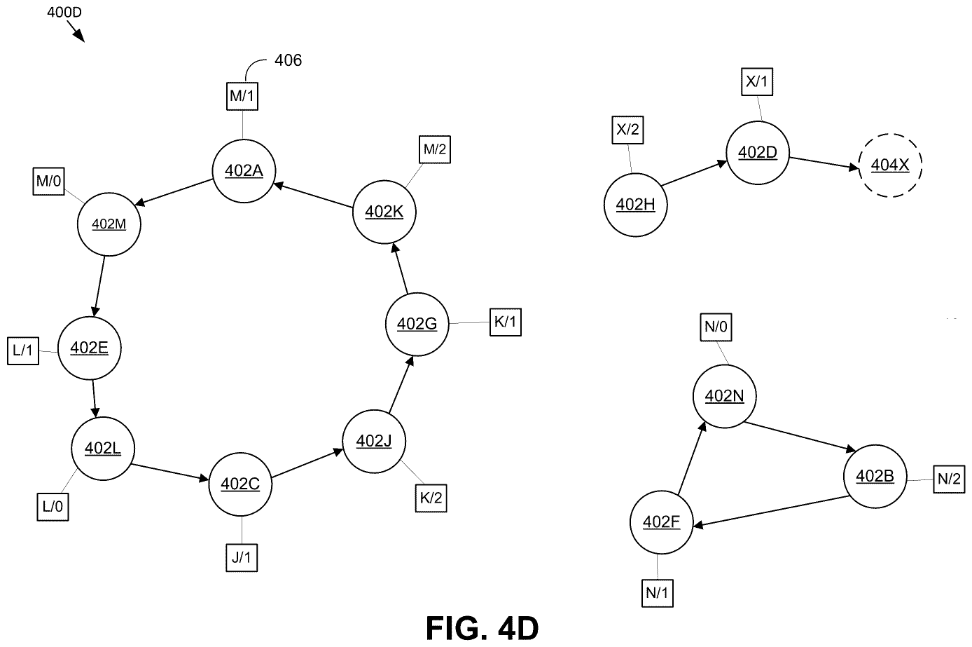

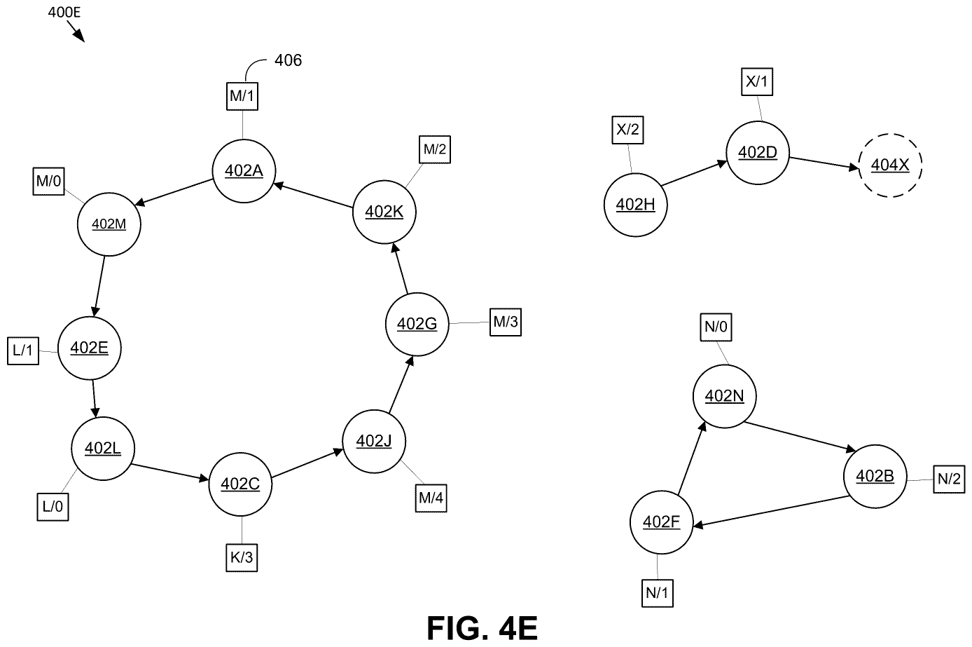

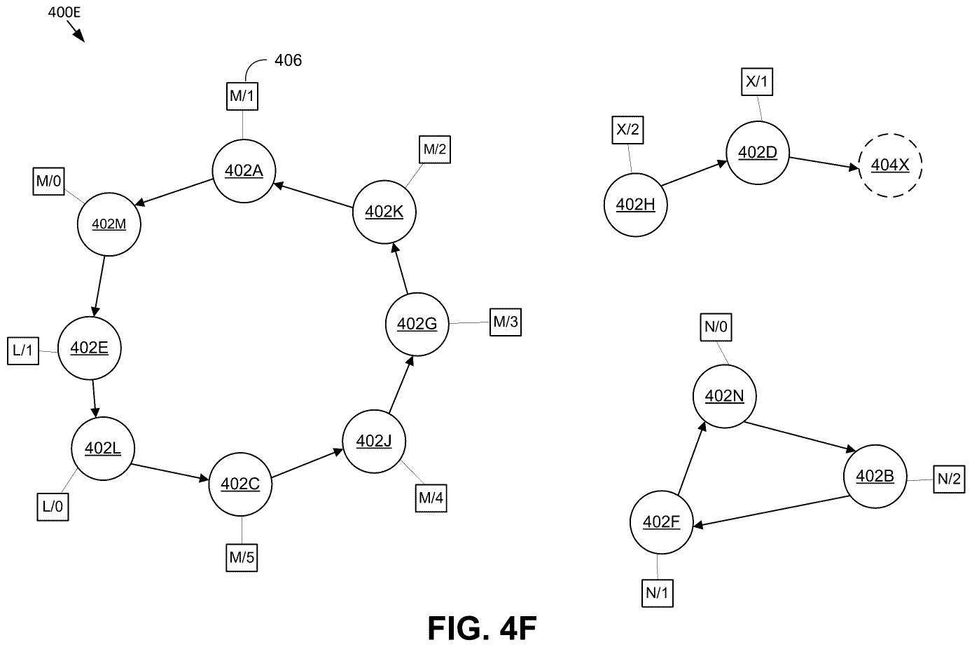

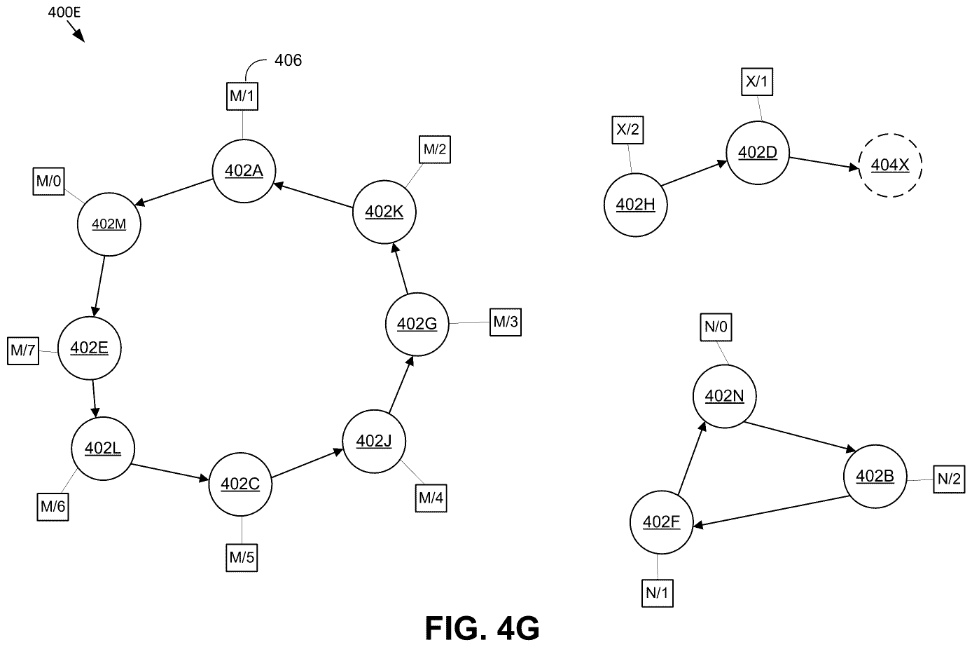

In some implementations, the graph processor 116 can implement a touch-scatter function to identify cycles/loops within the directed graph. The operations of the touch-scatter function can be executed in parallel. In one example, the graph processor 116 can initiate multiple threads, kernels, and/or processes to execute different potions of the touch-scatter function. In some implementations, this may include initializing one or more regions of memory of parallel processing devices using data of the directed graph, segment information, or other information to perform the touch-scatter function. Diagrams illustrating an example representation of the touch-scatter function are shown in FIGS. 4A-4G.

Referring to FIGS. 4A, 4B, 4C, 4D, 4E, 4F, and 4G in the context of the components described in connection with FIG. 1, depicted are example diagrams 400A, 400B, 400C, 400D, 400E, 400F, and 400G showing a touch-scatter process for detecting cycles/loops in an example directed graph, in accordance with some embodiments of the present disclosure. FIG. 4A shows an example directed graph including nodes 402A-402M (sometimes generally referred to as the “node(s) 402”, note that node 402I omitted for visual clarity). The example directed graph shown in FIGS. 4A-4G can be generated by the graph generator 114 according to the techniques described herein from a corresponding set of input polygons 110 for a Boolean operation. As shown, the directed graph also includes a dummy node 404X.

To initialize the touch-scatter process, each node can be associated with a respective label 406. In this example, each label 406 includes an alphabetical label (e.g., A, B, C, etc.) and a numerical step counter, separated by a forward slash character. Each label 406 can be initialized to a value that is unique to the node 402 to which it corresponds, with the step counter initialized to zero. The dummy node 404X may not be associated with a label. Although shown as connected to the nodes with lines, the labels 406 are not nodes in the graph, and are instead only associated with the nodes 402 to which they connect. The labels assigned to each of the nodes may correspond to the order that the corresponding incoming segments appear in the sorted list of links 117 used to generate the directed graph. For example, the label “A” corresponds to the node 402A, which can be generated to represent the first link 117 in the set of sorted links 117 (e.g., having the lowest incoming segment values, etc.).

FIG. 4B shows a first iteration of the touch-scatter process, during a “touch” phase of the algorithm. At this iteration, the label of each node can be compared to the label 406 of the node to which it connects (e.g., as a source node). If the label 406 of the current node is less than the label 406 of the node to which it connects, and the step counter for the current node is less than or equal to the step counter of the node to which it connects, the graph processor 116 can update the label 406 of the current node to have the label value (e.g., the letter value, this example) of its neighbor (e.g., the greater label value).

The step counter for any updated labels 406 are incremented by one. As shown in this example, this results in the label 406 for the node 402A being updated to “M/1,” the label 406 for the node 402G being updated to “K/1,” the label 406 for the node 402C being updated to “J/1,” the label 406 for the node 402E being updated to “L/1,” the label 406 for the node 402F being updated to “N/1,” and the label 406 for the node 402B being updated to “F/1.” If a node points to a dummy node (e.g., like the node 402D in this example), the label 406 of the node 402 can be updated to a value representing the dummy node. In this example, the label 406 for the node 402G can be updated to “X/1,” with the value “X” representing the dummy node.

FIG. 4C shows the next iteration of the touch-scatter function, during the “scatter” phase. In the scatter phase, the label 406 of each node 402 that has a non-zero step value is compared to the label of the node 402 to which it connects (e.g., the node it points to) to determine whether that node 402 points to a “head node” (e.g., a node 402 with the same label value having a step counter of “0”). If the value of the label 406 to which the node 402 connects is not the same label value, and that label value is greater than the label value of the current node 402, the graph processor 116 can update the label 406 of the current node 402, and any other nodes 402 having the same label and connected thereto, to have the greater label value. The step counter for each updated node 402 can be set to the value of the step counter of the neighbor node 402 (e.g., the node 402 to which it points) plus one, in some implementations. The scatter step of the touch-scatter function updates each set of nodes 402 sharing a label value (e.g., “A,” “B,” etc.) that do not connect to a corresponding head node 402. In this example, the label 406 of the node 402B is updated to “N/2.” Labels 406 of other nodes 402 in this example iteration are either head nodes or connect to a head node, and therefore are not updated.

FIG. 4D shows a diagram 400D representing the next iteration of the touch-scatter process, during a second touch phase of the algorithm. At this iteration, the label 406 of each node 402 can be compared to the label 406 of the node to which it connects. If the label 406 of the current node is less than the label 406 of the node to which it connects, and the step counter for the current node is less than or equal to the step counter of the node to which it connects, the graph processor 116 can update the label 406 of the current node to have the label value (e.g., the letter value, this example) of its neighbor (e.g., the greater label value).

The step counter of the updated label 406 can be set to the value of the neighbor's step counter incremented by one, in this example. As shown in this example, this results in the label 406 for the node 402K being updated to “M/2,” the label 406 for the node 402J being updated to “K/2,” and the label 406 for the node 402H being updated to “X/2.” As the node 402N (e.g., the head node for the label 406 having the value “N”) points to a node having the same label value, the graph processor 116 can determine that the nodes 402N, 402B, and 402F form a cycle/loop within the graph. Further processing operations for these nodes can be skipped/ignored during subsequent processing iterations of the algorithm, in some implementations. The graph processor 116 can determine that the nodes 402H and 402D and the dummy node 404X each share the same label value and are not connected to any other nodes in the directed graph. As each of these share a label corresponding to a dummy node, the segments associated with these nodes can be skipped/ignored in subsequent processing operations and omitted from the dataset used to generate output polygons 124, as described in further detail herein.

FIG. 4E shows a diagram 400E of the next iteration of the touch-scatter function, during a second scatter phase. As described herein, during the scatter phase, the label 406 of each node 402 that has a non-zero step value is compared to the label of the node 402 to which it connects (e.g., the node it points to) to determine whether that node 402 points to a “head node” (e.g., a node 402 with the same label value having a step counter of “0”). If the value of the label 406 to which the node 402 connects does not have the same label value, and that label value is greater than the label value of the current node 402, the graph processor 116 can update the label 406 of the current node 402, and any other nodes 402 having the same label and connected thereto, to have the greater label value. The step counter for each updated node 402 can be set to the value of the step counter of the neighbor node 402 (e.g., the node 402 to which it points) plus one, in some implementations. In this example, the label 406 of the node 402G is updated to “M/3,” the label 406 of the node 402J is updated to “M/4,” and the label 406 of the node 402C is updated to “K/3,” as shown. Labels 406 of other nodes 402 in this example iteration are either head nodes or connect to a head node (e.g., directly or indirectly through nodes having the same label value), and therefore are not updated.

FIG. 4F shows a diagram 400F following an iteration of a subsequent touch phase of the touch-scatter algorithm and a subsequent scatter phase of the touch-scatter algorithm. In this example, the touch phase does not affect the labels 406 associated with any nodes that are to be processed (e.g., are not ignored/skipped). During the scatter phase, the label 406 of the node 402C is updated to “M/5,” as shown. FIG. 4G shows a diagram 400G following an iteration of a subsequent touch phase of the touch-scatter algorithm and a subsequent scatter phase of the touch-scatter algorithm. Using the techniques described herein, the graph processor 116 can update the label 406 of the node 402L during a subsequent touch phase and can update the label 406 of the node 402E during a subsequent scatter phase.

Following the scatter phase, the graph processor 116 can determine that the head node 402 (e.g., having a label 406 “M/0”) points to another node (in this example, 402E) having a label value of the same value (e.g., “M”). Upon identifying this connection, the graph processor can determine that a cycle/loop has been identified in the directed graph and can traverse each of the nodes 402 (e.g., following the direction of the directed edges) to identify each node 402 in the cycle/loop. In this example, the nodes in the larger cycle/loop include the node 402M, the node 402E, the node 402L, the node 402C, the node 402J, the node 402G, the node 402K, and the node 402A (which points to the node 402M, the head node of the cycle/loop). Nodes 402 included in each loop/cycle identified in the directed graph, as well as any information relating to the links 117 associated therewith, can be provided to the polygon generator 118 to generate one or more output polygons 124.

Referring back to FIG. 1, the data processing system 102 can access the identifiers of nodes identified as belonging to cycles in the directed graph generated by the graph processor 116. Each node belonging to a cycle/loop in the directed graph can represent a corresponding output polygon 124 (which may be provided on a single output layer of polygons, in some implementations). To generate an output polygon given a set of node identifiers (e.g., node identifiers shown in FIG. 3E, etc.) in a cycle/loop identified in the directed graph, the polygon generator 118 can use the node identifiers to lookup the corresponding link 117 in the set of links 117 identified by the intersection identifier 112. The coordinate values of the incoming segment for a link 117 associated with a node identifier can be used to generate a vertex of an output polygon. The coordinate values of each vertex in the output polygon 124 can be set to the coordinate values provided in the incoming segment for each link 117.

Connections between the vertices in the output polygon can be generated based on the connections in the cycle of the directed graph. For example, each edge in the directed graph can be used to connect two corresponding vertices as an edge in the output polygon 124. As each set of nodes provided by the graph processor 116 is a closed cycle/loop, each set of corresponding vertices forms a corresponding closed output polygon 124 that represents the output of the Boolean operation. The polygon generator 118 can generate a corresponding output polygon 124 for each cycle/loop identified in the directed graph. In some implementations, if the polygon generator 118 generates multiple output polygons 124, all generated output polygons 124 can be generated as part of the same output polygon layer. For example, each generated output polygon may be stored in a data structure corresponding to the polygon layer and/or stored in association with an identifier of the output polygon layer.

The data processing system 102 can provide the output polygon(s) 124 in response to a request to perform the Boolean operation. This may include providing the output polygon(s) 124 to one or more external computing systems, providing the output polygon(s) 124 to one or more processes executing on the data processing system 102, and/or providing/presenting the output polygon(s) 124 to an operator of the data processing system 102. In some implementations, the data processing system 102 can store the output polygon(s) 124 in one or more regions of memory of the data processing system 102, for example, in association with identifiers of the corresponding input polygons 110 and/or an indication of the Boolean operation performed to generate the output polygon(s) 124.

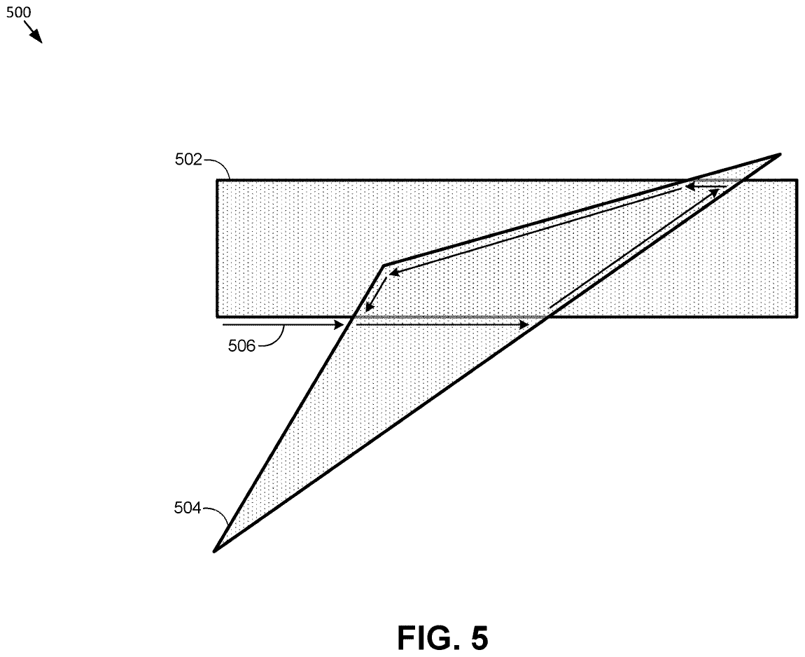

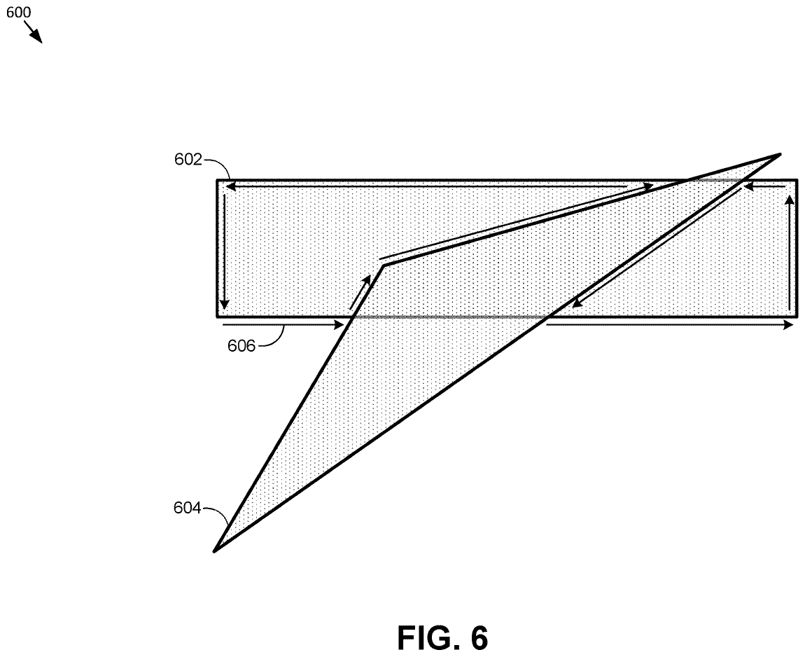

In some implementations, the data processing system 102 may use the output polygon(s) 124 generated in a first Boolean operation as a set of input polygons for a subsequent Boolean operation. In some implementations, Boolean operations, such as XOR operations, may be performed using combinations of other Boolean operations. For example, the XOR operation “A XOR B” (where A and B represent sets of input polygons for the XOR operation) can be equal to “(A NOT B) OR (B NOT A),” or in the alternative, “(A OR B) NOT (A AND B).” To implement such operations, the data processing system 102 can perform the corresponding component Boolean operations (e.g., sequentially or in parallel, etc.) until a final output is provided. Although examples described herein are discussed in connection with Boolean OR operations, it should be understood that the data processing system 102 can implement the techniques described herein to carry out any type of Boolean operation, including Boolean NOT operations, Boolean AND operations, and Boolean XOR operations (e.g., using one of the equivalent combinations of OR, AND, and NOT operations provided above, etc.). Examples of how the data processing system can implement Boolean AND operations and Boolean NOT operations are described in connection with FIGS. 5 and 6.

Referring to FIGS. 5 and 6 in the context of the components described in connection with FIG. 1, depicted are example diagrams 500 and 600 showing how the intersection identifier 112 can search edges 120 of input polygons to implement a Boolean AND operation and a Boolean NOT operation, respectively. As shown in the diagram 500 of FIG. 5, to implement a Boolean AND operation between a first polygon 502 and a second polygon 504, the intersection identifier can perform similar searching operations 506 as those described in connection with FIGS. 2A, 2B, and 2C, but creating links when left-hand turns are detected, rather than right-hand turns. In the illustrated example, this results in a set of links that result in a closed region corresponding to the overlap of the first polygon 502 and the second polygon 504. After generating a directed graph and extracting corresponding closed cycles/loops within the cycle graph, the output polygon 124 generated according to the techniques described herein represent an AND operation between the first polygon 502 and the second polygon 504.

As shown in the diagram 600 of FIG. 6, to implement a Boolean NOT operation between a first polygon 602 and a second polygon 604 (e.g., first polygon 602 NOT second polygon 604), the intersection identifier can perform similar searching operations 606 as those described in connection with the Boolean AND operation of FIG. 5. However, prior to performing the search, the intersection identifier 112 can reverse the winding number of the second operand in the Boolean NOT operation (e.g., the second polygon 604). In the illustrated example, this results in a set of links that result in multiple closed regions corresponding to the regions of the first polygon 602 that do not overlap the second polygon 604. After generating a directed graph and extracting corresponding closed cycles/loops within the cycle graph, the multiple output polygons 124 generated according to the techniques described herein represent a NOT operation between the first polygon 602 and the second polygon 604.

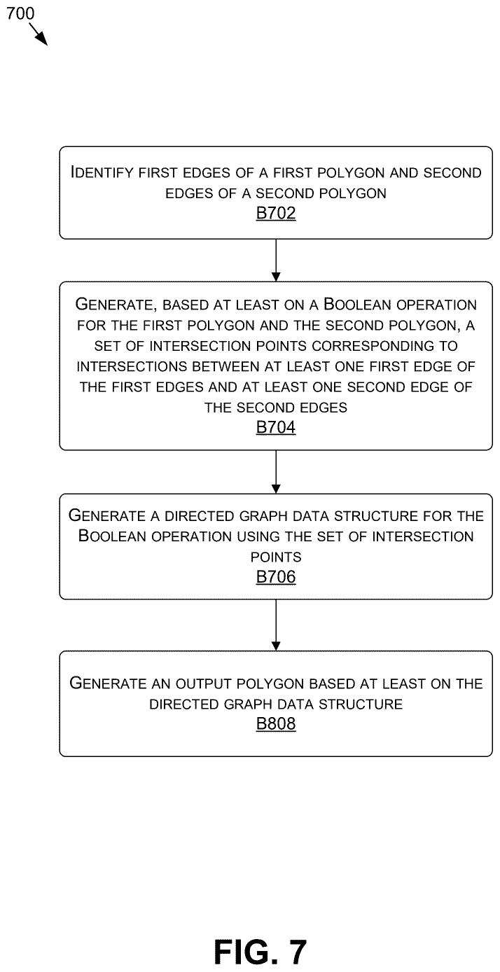

Now referring to FIG. 7, each block of method 700, described herein, includes a computing process that may be performed using any combination of hardware, firmware, and/or software. For instance, various functions may be carried out by one or more processors executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 700 is described, by way of example, with respect to the system of FIG. 1. However, this method may additionally or alternatively be executed by any one system, or any combination of systems, including, but not limited to, those described herein.

FIG. 7 is a flow diagram showing a method 700 for implementing parallel computation of Boolean logic operations between 2D geometric polygon sets, in accordance with some embodiments of the present disclosure. The method 700, at block B702, includes identifying first edges (e.g., edges 120) of a first polygon (e.g., a first input polygon 110) and second edges (e.g., edges 120) of a second polygon (e.g., a second input polygon 110) for a Boolean operation. The polygon edge information may be identified based on operator input to the computing system performing the method 700 (e.g., the data processing system 102), from a request received from an external computing system (e.g., via an API request, etc.), or from another computing process. The first polygon may be defined in a first layer of multiple first polygons (e.g., a first operand for a Boolean operation) and the second polygon may be defined in a second layer of multiple second polygons (e.g., a second operand for the Boolean operation).

The method 700, at block B704, includes generating based at least on a Boolean operation for the first polygon and the second polygon, a set of intersection points (e.g., the intersection points 115) corresponding to intersections between at least one first edge of the first edges and at least one second edge of the second edges. To do so, a searching operation may be performed similar to those described in connection with the intersection identifier 112 of FIG. 1. Searching for intersections can include searching along a winding direction of one or more edges. In some implementations, if the Boolean operation is an OR operation, intersections can be detected when an intersecting edge of the second polygon results in a right turn. In some implementations, if the Boolean operation is an AND operation (or a NOT operation), intersections can be detected when an intersecting edge of the second polygon results in a left turn. Intersection points may be used to generate links (e.g., the links 117), as described herein.

The method 700, at block B706, includes generating a directed graph data structure (e.g., a directed graph similar to that shown in FIG. 3F, etc.) using the set of intersection points. To do so, any of the operations described in connection with the graph generator 114 can be performed. For example, generating the graph data structure may include sorting a list of links by incoming segment, generating dummy segments as described herein, and assigning index values to each link. Once index values are assigned to each link, the outgoing segments of each link can be sorted according to the segment information (e.g., layer identifier, edge identifier, intersection point coordinates, etc.) of each outgoing segment. The resulting pair of index values can represent a connect between links in a directed graph generated as a one-to-one permutation. To generate the directed graph, each link can be represented as a corresponding node, and directed edges can be generated according to the associations indicated by the index value pairs.

The method 700, at block B708, includes generating an output polygon (e.g., the output polygon 124) based at least on the directed graph data structure. To do so, any of the operations described in connection with the graph processor 116 and the polygon generator 118 can be performed. For example, a touch-scatter function can be executed to automatically identify any closed cycles/loops within the directed graph data structure. Each cycle/loop identified in the directed graph can correspond to an output polygon for the Boolean operation. Output polygons can be generated from the cycles/loops in the directed graph by accessing the respective coordinates of an incoming segment associated with each node (e.g., the corresponding link 117). Vertices for an output polygon can be connected according to the connections between corresponding nodes in the directed graph, with each closed loop/cycle forming a closed set of edges defining a positive or negative polygon. Generated output polygons can be provided as the output of the Boolean operation.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), light transport simulation (e.g., ray-tracing, path tracing, etc.), collaborative content creation for three-dimensional (3D) assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models such as one or more small language models (SLMs), one or more large language models (LLMs), or one or more vision language models (VLMs), systems for performing light transport simulation, systems for performing collaborative content creation for 3D assets, systems implemented at least partially using cloud computing resources, and/or other types of systems.

Approaches in accordance with various embodiments can be used to generate one or more parameters for a content generation environment. In at least one embodiment, a trained machine learning (ML) and/or artificial intelligence (AI) system, such as a large language model (LLM) or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, VLM, etc.) that can then generate one or more settings in accordance with the input. Various embodiments may be used to generate settings in two-dimensional (2D) or three-dimensional (3D) settings. For embodiments that incorporate one or more language models-that is, one or more LLMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

### Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). As such, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that allow the computing device 800 to communicate with other computing devices via an electronic communication network, included wired and/or wireless communications. The communication interface 810 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may allow the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that allow detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to allow the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Data Center

FIG. 9 illustrates an example data center 900 that may be used in at least one embodiments of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R.s 916(1)-916(N) may include one or more virtual components, such as vGPUs, vCPUs, and/or the like, and/or one or more of the node C.R.s 916(1)-916(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 928, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may use distributed file system 938 for large-scale data processing (e.g., “big data”). In at least one embodiment, job scheduler 928 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 928. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
identify a plurality of first edges of a first polygon and a plurality of second edges of a second polygon;
generate, based at least on a Boolean operation for the first polygon and the second polygon, a set of intersection points corresponding to intersections between at least one first edge of the plurality of first edges and at least one second edge of the plurality of second edges;
generate a directed graph data structure for the Boolean operation using the set of intersection points; and
generate an output polygon based at least on the directed graph data structure.

2. The one or more processors of claim 1, wherein the Boolean operation comprises an OR operation, an AND operation, an XOR operation, or a NOT operation.

3. The one or more processors of claim 1, wherein the one or more circuits are to:
generate an index value for each of the set of intersection points;
identify a plurality of index value pairs based at least on the index value of each of the set of intersection points; and
generate the directed graph data structure based at least on the plurality of index value pairs.

4. The one or more processors of claim 3, wherein the one or more processors are to:
generate the directed graph data structure based at least on a sort by key operation for the plurality of index value pairs, or a binary search operation.

5. The one or more processors of claim 3, wherein the one or more circuits are to:
identify at least one of the plurality of index value pairs based at least on a first coordinate of a first intersection point of the set of intersection points being within a threshold distance of a second intersection point of the set of intersection points.

6. The one or more processors of claim 3, wherein the one or more circuits are to:
generate a dummy value for at least one of the set of intersection points to generate the plurality of index value pairs.

7. The one or more processors of claim 6, wherein the one or more circuits are to:
generate the dummy value for a first intersection point of the set of intersection points that fails to match with a corresponding second intersection point of the set of intersection points.

8. The one or more processors of claim 1, wherein the one or more circuits are to:
generate the output polygon based on at least one cycle identified in the directed graph data structure.

9. The one or more processors of claim 1, wherein the one or more circuits are to:
reverse a winding direction for one of the plurality of second edges of the second polygon or the plurality of first edges of the second polygon based at least on the Boolean operation.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a multi-modal language model;
a system for performing generative AI operations using a small language model (SLM);
a system for performing generative AI operations using a large language model (LLM);
a system for performing generative AI operations using a vision language model (VLM);
a system for generating synthetic data;
a system incorporating one or more virtual machines (VMs);
a system using or deploying one or more inference microservices;
a system that incorporates one or more machine learning models deployed in a service or microservice along with an OS-level virtualization package (e.g., a container);
a system implemented at least partially in a data center; or
a system implemented at least partially using cloud computing resources.

11. A system, comprising:
one or more processors to:
generate a set of links from of a plurality of edges of a layer of polygons based at least on a polygon operation;
generate a directed graph data structure based at least on a sorting operation for the set of links, each node in the graph corresponding to a respective coordinate;
identify at least one cycle within the directed graph; and
provide an output layer of polygons generated based at least on the respective coordinate of each node in the cycle of the directed graph.

12. The system of claim 1, wherein the one or more processors are to:
receive the first layer of polygons from a computer-aided design (CAD) application.

13. The system of claim 1, wherein the polygon operation is a Boolean operation, wherein the plurality of edges of the layer of polygons is a plurality of first edges of a first layer of polygons, and wherein the one or more processors are to:
detect an intersection between a first edge of the plurality of first edges and a second edge of a plurality of second edges of a second layer of polygons; and
generate a first link of the set of links based at least on a start point of the first edge and an intersection point between the first edge and the second edge.

14. The system of claim 13, wherein the Boolean operation comprises an OR operation, and wherein the one or more processors are to:
determine, based on winding directions of the first edge and the second edge, that the intersection between the first edge and the second edge corresponds to a right turn; and
responsive to determining that the intersection between the first edge and the second edge corresponds to the right turn, generate a second link of the set of links based at least on (i) the intersection point between the first edge and the second edge, and (ii) one of a second intersection or an end point of the second edge.

15. The system of claim 13, wherein the Boolean operation comprises an AND operation, and wherein the one or more processors are to:
determine, based at least on winding directions of the first edge and the second edge, that the intersection between the first edge and the second edge corresponds to a left turn; and
responsive to determining that the intersection between the first edge and the second edge corresponds to the left turn, generate a second link of the set of links based at least on (i) the intersection point between the first edge and the second edge, and (ii) one of a second intersection or an end point of the second edge.

16. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a multi-modal language model;
a system for performing generative AI operations using a large language model (LLM);
a system for performing generative AI operations using a vision language model (VLM);
a system for generating synthetic data;
a system incorporating one or more virtual machines (VMs);
a system using or deploying one or more inference microservices;
a system that incorporates one or more machine learning models deployed in a service or microservice along with an OS-level virtualization package (e.g., a container);
a system implemented at least partially in a data center; or
a system implemented at least partially using cloud computing resources.

17. A method, comprising:
identifying, using one or more processors, a plurality of first edges of a first polygon and a plurality of second edges of a second polygon;
generating, using the one or more processors, based at least on a Boolean operation for the first polygon and the second polygon, a set of intersection points corresponding to intersections between at least one first edge of the plurality of first edges and at least one second edge of the plurality of second edges;
generating, using the one or more processors, a directed graph data structure for the Boolean operation using the set of intersection points; and
generating, using the one or more processors, an output polygon based at least on the directed graph data structure.

18. The method of claim 17, wherein the Boolean operation comprises an OR operation, an AND operation, an XOR operation, or a NOT operation.

19. The method of claim 17, further comprising:
generating, using the one or more processors, an index value for each of the set of intersection points;
identifying, using the one or more processors, a plurality of index value pairs based at least on the index value of each of the set of intersection points; and
generating, using the one or more processors, the directed graph data structure based at least on the plurality of index value pairs.

20. The method of claim 19, further comprising:
generating, using the one or more processors, the directed graph data structure based at least on a sort by key operation for the plurality of index value pairs or based at least on a binary search operation.
